(19) United States
(12) Patent Application Publication
(10) Pub. No.: US 2007/0110780 A1
(43) Pub. Date: May 17, 2007

(54) Building material surface treatment biocide, and method for treatment of building material surfaces

(75) Inventor: Stephen J. Gorton, Rowlett, TX (US)

Correspondence Address: BERENATO, WHITE & STAVISH, LLC, 6550 ROCK SPRING DRIVE, SUITE 240, BETHESDA, MD, 20817, US

(73) Assignee: nzymSys, IP Inc.

(21) Appl. No.: 11/271,968

(22) Filed: Nov. 14, 2005

(51) Int. Cl. A01N 65/00; A01N 25/00

(52) U.S. Cl. 424/405; 424/754; 424/767

(57) ABSTRACT

A building surface treatment biocide is provided for the treatment of offending bacteria, fungi, mycelium, spores and proteins on surfaces of common building materials, such as residential and commercial dwellings, office space, public schools, government buildings, modular buildings, and transportation systems. According to an embodiment of the invention, the biocide contains a nonionic surfactant, an antimicrobial agent, and a botanical extract of a plant selected from the Liliaceae and Cactus families, the extract retaining the active enzymes and amino acids of the plant. Also provided are methods of making and applying the biocide. Preferred application techniques include spray, atomization, and fumigation.

### FIELD OF THE INVENTION

The present invention relates to compositions especially suited for treating and inhibiting microbial growth and infestation on building materials, including materials used in the construction of residential dwellings and commercial properties. The present invention further relates to a method of making the compositions, and to methods of applying the compositions to building material surfaces.

### BACKGROUND OF THE INVENTION

It is well known that mold, mildews, and other fungi favor growth in humid environments. Specific examples of common offending fungi include Aspergillus fumigatis, Aspergillus niger, Aspergillus versicolor, Cladosporium, and Penicillium spp. High humidity and moisture is usually associated with the outdoors, where fungi growth can produce an unsightly appearance on building facades. Indoor environments also often possess adequate humidity and moisture to support the growth of fungi. Indoor building materials that are susceptible to mold growth include, for example, sheet rock, carpets, wood surfaces, and bathroom ceramic tile. Mold growth can quickly germinate into spores and create mycotoxins, which can then spread from a single room or area throughout the interior of the building by air handling systems, such as air conditioner and heating vents. The spread of mold spores and mycotoxins into populated building areas increases exposure levels to building occupants and complicates remediation efforts.

It is well known and documented that chronic exposure to fungi and resulting spores and mycotoxins manifests as various health problems within humans. Numerous laboratories throughout the country, including the University of Florida, INX Laboratories, Inc., of Claremont, Fla., and medical researchers including the Mayo Clinic, have identified several of the offending fungi species and connected the same to health concerns. For example, it has been reported that exposure to fungus, such as mold, leads to allergies and various other health risks, including respiratory disease and immune system vulnerability, especially among those predisposed by age or genetics to be at high risk. The dissemination of such reports and other documentation relating to human health risks of extended fungi exposure has been blamed for causing collateral health problems. It has been argued that public concern for these health risks has resulted in the over-prescription of certain antibiotics, steroids, and other drugs used to treat such illnesses.

Bacterial growth is another infestation problem found in and on building structures that can lead to various health problems. Common offending microorganisms include gram-negative bacteria such as Escherichia coli, Pseudomonas spp (aeruginosa), and Pseudomonas folliculitis, and gram-positive cocci such as Staphylococcus aureus. These bacteria can cause health problems such as dermal infections, respiratory infections, intestinal infections, and kidney disease.

The financial cost for the medical treatment of allergies and health-related illnesses resulting from fungal and bacterial exposure, including asthma and bronchial infections, are estimated to be in the billions. For example, it has been reported that in a recent 10-year span, pharmaceutical sales of prescriptions for treating asthma-related illness and other lung and upper respiratory diseases have increased approximately five-fold, with annual costs for prescription drugs exceeding 30 billion dollars. Medical and health insurance costs have escalated at twice the rate of inflation during the same period, seriously impacting the profit margins of small and large business owners alike.

The financial impact of fungi and bacteria contamination of buildings is not limited to medical expenses. Homeowners and commercial property owners are faced with the high cost and inconvenience of removing contamination. Residential and commercial properties also are prone to extensive devaluation due to the contamination. Lower property values have an adverse financial impact on both the owners and state and local governments, which collect less tax revenues for devalued property. The decreased tax income attributable to property devaluation strains the financial ability of the state to implement corrective measures. The resulting financial constraints can lead to neglect or postponement of remediation and restoration efforts, leaving the human health risk intact beyond a reasonable time if not indefinitely. Another example of the adverse financial impact caused by fungal and bacterial contamination of buildings is escalating insurance costs for homeowners and commercial property owners. The financial impact is also felt by the insurance companies, which may elect to exclude or cancel mold coverage from policies covering high risk properties.

Current remediation and restoration technologies for removal of fungal and bacterial contaminants and byproducts from buildings rely heavily upon older, toxic chemical products such as bleaches and alkaline-based washes that deliver less than entirely satisfactory results. Also, the high toxicity to humans of these products raises additional human health risks. Other traditional remedies for microbial removal are the renovation and demolition/reconstruction of a building. Both of these options are expensive and inefficient, often requiring displacement of the building occupants to another dwelling. Further, neither of these options has demonstrated reliability in delivering consistent and permanent results. Common problems among remediation contractors resulting is the recurrence of the contaminants, especially in the air handling system or the HVAC coil, where mold germination occurs. Within weeks or months, the bacteria, fungi and its spores and mycotoxins can return and once again cause discomfort and illness. The poor performance of existing technology and reoccurring problems exhibited in treated buildings can result in lawsuits against the contractors and remediators, whose products and methodologies lack satisfactory effectiveness and reliability.

It would be a considerable advantage to property owners and others financially affected by the property cleanliness and value, including occupants, residents, insurers, mortgage lenders, property management firms, realtors, state and local governments, and the like, if these damaging microbial infestations could be eliminated or at least substantially curtailed from reoccurrence. Therefore, there is an immediate and long-felt need for the technology of this invention, which in a preferred embodiment addresses the concerns noted above.

### SUMMARY OF THE INVENTION

An object of the invention is to provide a composition that demonstrates antimicrobial activity or properties. As used herein, the terms biocide and antimicrobial shall mean to function as a fungicide and/or bactericide by eradicating or reducing existing bacterial and/or fungal growth, and/or preventing, suppressing, and/or inhibiting the infestation or recurrence of bacteria and fungus on a surface of a building material, especially a material that constitutes a building indoor surface area.

It is another object of the invention to provide a method for treating the surface of a building material, especially a building indoor surface area, with a biocide to eradicating or reduce existing harmful microbial (e.g., bacterial and/or fungal) growth on the surface, and preferably also to inhibit the infestation or recurrence of harmful microbes on the surface.

Yet another object of the invention is to provide a building material surface treatment biocide and method suited for the remediation and restoration industries, and capable of being incorporated into existing cleaning and remediation programs and equipment used by service contractors, building contractors, and remediation and cleaning companies.

A further object of the invention is to provide a building material surface treatment biocide and method that are environmentally and occupationally safe, and preferably suitable for classification as in a generally recognized as safe (GRAS) status.

Still a further object of the invention is to provide a non-toxic biocide and method capable of protecting humans against excessive exposure to potential health risks caused by contaminants such as bacteria, fungi, spores, and/or mycotoxins, especially those contaminants found indoors in such places as public schools, government offices, commercial buildings, homes and the like.

To achieve one or more of the foregoing objects, and in accordance with the purposes of the invention as embodied and broadly described herein, a first aspect of this invention provides a building material surface treatment biocide containing at least a nonionic surfactant, an antimicrobial agent, and a botanical extract of a plant selected from the Liliaceae and Cactus families, wherein the botanical extract retains the active enzymes and amino acids of the plant. As used herein, the phrase “a plant selected from” is Markush language, and means Liliaceae, Cactus, or a combination of Liliaceae and Cactus.

In accordance with a second aspect of the invention, a method is provided for the anti-microbial treatment of a building material surface. The method comprises contacting a building material surface with an effective amount of a biocide to treat microbial growth. The biocide contains at least a nonionic surfactant, an antimicrobial agent, and a botanical extract of a plant selected from the Liliaceae and Cactus families, wherein the botanical extract retains the active enzymes and amino acids of the plant.

In accordance with a third aspect of the invention, one or more of the foregoing objects is achieved by providing a building material surface treatment aqueous biocide containing aseptic water, a nonionic surfactant, and a botanical extract of a plant selected from the Liliaceae and Cactus families.

A fourth aspect of the invention features a method of treating a building-material surface with an aqueous biocide containing aseptic water, a nonionic surfactant, and a botanical extract of a plant selected from the Liliaceae and Cactus families.

A fifth aspect of the invention provided for achieving one or more of the foregoing objects features a building material surface treatment biocide containing at least an enzyme, a nonionic surfactant, an antimicrobial agent, mucilaginous polysaccharides, a penetrant, and an amino acid.

In accordance with a sixth aspect of the invention, a method is provided for the anti-microbial treatment of a building material surface. The method comprises contacting a building-material surface with an effective amount of a biocide to treat microbial growth. The biocide contains at least an enzyme, a nonionic surfactant, an antimicrobial agent, mucilaginous polysaccharides, a penetrant, and an amino acid.

Other aspects of making the invention, including additional compositions and methods, will become apparent from the following detailed description.

### DETAILED DESCRIPTION OF PREFERRED EMBODIMENTS AND PREFERRED METHODS OF THE INVENTION

Reference will now be made in detail to the preferred embodiments and methods of the invention. It should be noted that the invention in its broader aspects is not limited to the specific details, representative compositions and methods, and illustrative examples described in connection with the preferred embodiments and preferred methods. The invention according to its various aspects is particularly pointed out and distinctly claimed in the attached claims read in view of this specification, and appropriate equivalents.

A preferred embodiment of the invention relates to a building material surface treatment biocide containing at least one nonionic surfactant, at least one antimicrobial agent, and at least one botanical extract of a plant selected from the Liliaceae and Cactus families, wherein the extract retains the active enzymes and amino acids of the plant.

The biocide composition of the present invention preferably is aqueous based. Water is the principal ingredient of the biocide composition, preferably constituting at least about 8 weight percent up to about 35 weight percent, more preferably about 25 to about 30 weight percent of the composition. Distilled, aseptic water free of minerals, ions, and ion exchange components is preferred.

Water containing ions from salts and minerals has a deteriorating effect on proteins, amino acids, and enzymes. To prevent or at least retard the deteriorating effect, the biocide composition preferably includes at least one nonionic surfactant, preferably present in an effective amount to disperse the enzyme or enzymes homogeneously in aqueous solution. Numerous nonionic surfactants are known in the art and are suitable for use with the present invention. A preferred class of nonionic surfactants is ethoxylated surfactants, such as addition products of ethylene oxide with fatty alcohols, fatty acids, fatty amines, etc. Optionally, ethylene oxide may be replaced with a mixture of ethylene oxide and propylene oxide for the addition reaction. For the purposes of this and other embodiments, especially preferred nonionic surfactants include those selected from the group consisting of fatty acid (C₁₂₋₁₈) esters of sorbitan and fatty acid esters of ethoxylated (EO₅₋₁₀₀) sorbitans. More preferably, the surfactant is selected from mixtures of laurate esters of sorbitol and sorbitol anhydrides (sorbitan); mixtures of stearate esters of sorbitol and sorbitol anhydrides; and mixtures of oleate esters of sorbitol and sorbitol anhydrides. Representative commercially available surfactants falling within these categories include the following: polysorbate 20, which is a mixture of laurate esters of sorbitol and sorbitol anhydrides consisting predominantly of the monoester, copolymerized with about 20 moles of ethylene oxide (polyoxyethylene (20) sorbitan monolaurate); polysorbate 40 (polyoxyethylene (20) sorbitan monopalmitate); polysorbate 60 (polyoxyethylene (20) sorbitan monostearate); polysorbate 80 (polyoxyethylene (20) sorbitan monooleate); and any combination thereof. It should be understood that the above examples are not exhaustive. Other nonionic surfactants may be used in addition to or instead of the above sorbitan/sorbitol esters, provided that the surfactants are compatible with the other components of the composition and the selected pH. It is preferred to select non-foaming, low sodium, low foaming surfactants. For example, decyl glucoside is a suitable nonionic surfactant.

Although the solution is preferably free of surfactants other than nonionic surfactants, optionally one or more anionic surfactants may be mixed with the nonionic surfactant(s). In the case of a surfactant mixture, the nonionic surfactants preferably sufficiently dominate the surfactant mixture to prevent the anionic surfactant(s) from destabilizing the enzymes. Examples of anionic surfactants that may be used in combination with nonionic surfactants are sodium laureth sulfate and sodium lauroyl lactylate.

The surfactant component, including both the nonionic surfactant and optionally other surfactants, is present in a sufficient amount to help stabilize the enzymes, and preferably constitutes at least 20 weight percent of the total weight of the biocide composition. More preferably, the total amount of surfactants in the solution is in a range of about 25 weight percent to about 30 weight percent, although amounts up to 38 weight percent and higher may be employed. Preferably the ionic surfactant constitutes no more than about 5 weight percent of the total weight of the composition, more preferably about 1 to about 4 weight percent. The weight ratio of nonionic surfactant to anionic surfactant preferably is at least 4:1 or at least 6:1, depending upon the surfactants selected. For example, a biocide composition falling within these preferred ranges includes 5 weight percent sodium laureth sulfate, 20 weight percent polysorbate-20, 5 weight percent polysorbate-80, and 5 weight percent decyl glucoside.

The biocide composition desirably includes an antimicrobial agent (or preservative) in an effective amount to prevent or substantially reduce the degree to which microorganisms present in the biocide denature the enzymes and breakdown other organic compounds, e.g., amino acids. The antimicrobial agent preferably yet optionally constitutes about 0.0001 weight percent to 5.0 weight percent, more preferably at least about 0.001 weight percent, and still more preferably at least about 0.01 weight percent of the total weight of the biocide. The selected agent preferably retains all or most of its effectiveness at the selected pH. Preferably, the antimicrobial agent also is safe to humans at the above concentrations, and does not present serious environmental hazards. Representative preservatives suitable for use with this and other embodiments include Kathon CG® sold by Rohm & Haas and ChemPoint, Inc. Kathon CG® has as its active ingredients 5-chloro-2-methyl-4-isothiazolin-3-one and 2-methyl-4-isothiazolin-3-one. Other antimicrobial agents consistent with the uses of the invention may be used in addition to or instead of Kathon CG®. Representative examples of suitable preservatives include other isothiazolin compounds and mixtures; parabens, such as alkyl parabens (e.g., propyl paraben and/or methyl paraben); potassium sorbate; and sodium benzoate. Commercial sources of the above and other preservatives include CBI Laboratories, Inc. of Ft. Worth, Tex., First City Chemical, Inc. of Garland, Tex., and UNIVAR USA of Seattle, Wash.

The biocide composition of this embodiment further includes an extract or processed form of a plant of the family Liliaceae, preferably the genus Aloe and/or Lilium, and/or a plant of the Cactus family, preferably Opuntia. The selected species preferably comprises a cold-processed extract containing enzymes, amino acids, lignins, and mucilaginous polysaccharides. The composition preferably contains about 2 weight percent to about 25 weight percent extract, more preferably about 5 weight percent to about 10 weight percent.

The genus Aloe encompasses approximately 600 species of plant. Preferred yet not exclusive species of the genus Aloe useful for the purposes of this invention include, for example, Aloe barbadensis Miller, also more commonly known as Aloe vera, Aloe arbrorescens, Aloe arborescenes natalensis, Aloe plicatis, and Aloe ferox Miller. Aloe barbadensis Miller is particularly preferred. Aloe barbadensis Miller is native to the Mediterranean region, but also widely distributed in southern parts of North America (especially Mexico), Europe, and Asia. The center of the aloe leaf contains a clear mucilaginous gel or mucilage that is visually distinguishable from the mucilaginous yellow juice known as aloin present about the base of the plant leaves and adjacent the rind of the leaf. The extract and juice of Aloe barbadensis contain over 75 components, including various enzymes, mucilaginous polysaccharides, lipopolysaccharides, monosaccharides, amino acids, and lignin. Other components of the aloe include cholesterol, glycerol, glycerides, triglycerides, steroids, saponins, sterols, uric acid, and salicyclic acid. An example of a species falling within the Lilium genus is Lillium candidum.

Examples of species falling within the Opuntia genus include Opuntia strigil, Opuntia basilaris, Opuntia rufida, Opuntia phaeacanthra, Opuntia engelmannii, Opuntia erinacea, Opuntia humifusa, Opuntia phaecantha, Opuntia chlorotica, Opuntia polycanthra, Opuntia voilacea, Opuntia spinosbacca, Opuntia ilndheimeri, and Opuntia macrorhiza.

The botanical extract used in preferred embodiments of the invention is purchased from a supplier or processed under such conditions which retain the active enzymes of the plant. Common plant-based enzymes of aloe and other members of the Liliaceae and Cactus families include aliiase, alkaline phosphatase, amylase, carboxypeptidase, catalase, cellulase, lipase, and peroxidase. The extract may be obtained commercially or by processing using any of a variety of well known methods. Commercial sources of Aloe include American Aloe Produce, Inc. and AloeAmerican Products, Inc. A commercial source of Lilium is CBI Laboratories. Commercial sources of Opuntia include Oro Verde, Gordon Monnier of Mexico and CBI Laboratories, Inc. of Ft. Worth, Tex. Any part of the plant may be processed or extracted, such as the leaf, stem, or flower. The extract may be taken from the whole leaf or leaf center. The extract is preferably obtained using a cold-process or other technique that substantially preserves the natural mucilaginous polysaccharides, amino acids, and enzymes of the aloe with substantially no denaturing of the enzymes and substantially no breakdown of the amino acids. Heat processes, such as those in which the aloe or other plant is subject to elevated temperatures of, for example, 150° F.-160° F. for 45-60 minutes, that cause sterilization of the plant enzymes are preferably avoided. According to an example of a whole-leaf process technique, the leaves obtained from the Aloe barbadensis Miller plant were ground, treated with 2% cellulase, cold-filtered (e.g., with activated carbon), preserved (e.g., with sodium benzoate and/or potassium sorbate), and optionally lyophilized. The lyophilized powder was reconstituted with the chromatography solvent prior to use. In another example, the exudate from Aloe barbadensis Miller leaves was suspended in water, followed by contact with an appropriate chromatography solvent (e.g., acetones) prior to use.

While the benefits of topical application of aloe for the treatment of inflammation, burns, abrasions, bruises, infection, and other skin conditions are known, the inventor has discovered that the inclusion of aloe and other plants of the Liliaceae family in the building surface treatment biocide of this embodiment surprisingly enhances the antifungal and antibacterial activity of the composition.

Without wishing to be bound by any theory, it is believed that the improved antimicrobial activity realized by the addition of the botanical extract, manufactured preferably using the whole plant or leaf pursuant to a cold-process, to the composition embodied here is attributable, at least in part, to the mucilaginous polysaccharides and amino acids found in extract, especially in the case of Aloe barbadensis and similar aloes. It has been estimated that Aloe barbadensis includes 20 of the 22 human required amino acids and 7 essential amino acids. It is believed that the mucilaginous polysaccharides and amino acids function as binding agents to increase the time that the cell wall of an offending fungus or bacteria is left exposed to the biocide, thereby providing the biocide with sufficient opportunity to lyse the cell wall and membrane.

It is further believed that the improved antimicrobial activity realized by the inclusion of extract in the composition of this embodiment is attributable, at least in part, to lignin found in the extract. Without wishing to be bound by any theory, it is believed that lignin acts as a dispersant and penetrating agent. The lignin is believed to break down and remove soils, especially hydrophilic soils such as clays, which might otherwise insulate fungal and bacterial growth on a building surface. The active enzymes are thereby allowed to penetrate to and attack the offending biological contaminant.

The enzymes and amino acids of an Aloe plant exist in an environment, i.e., the mucilage, having a pH falling in the range of about 4.4 to about 4.7. In order to preserve the activity of the enzymes and assist the nonionic surfactants in the stabilization of these enzymes, the biocide is preferably produced, maintained, and stored within a pH range which will not adversely affect the biologically active constituents of the composition and will allow the biologically active constituents to exhibit desired activity levels. The optimum pH range for the growth of a majority of species of bacteria is about 5.5 to 7.5, although bacteria may grow within a pH range of about 4.3 to about 8.5 if subjected to optimum moisture conditions and nutrient supplies. Similarly, fungus grow rates are dependent upon pH, nutrient availability, moisture, and temperature. Fungus grows at accelerated rates within a pH range of 5.0 to 7.0, and as high as 8.0. It is preferred to formulate and retain the biocide composition of the present invention at a pH range falling outside the metabolism pH range of these organisms.

It has been found particularly beneficial to position the pH of the biocide in a range of about 3.1 to about 4.5, more preferably a range of about 3.2 to about 4.3 using one or more pH adjusting agents, typically acidic agents. Below a pH of about 3.1 to 3.2, the enzymes, amino acids, and other optional ingredients may denature. On the other hand, the pH preferably is equal to or lower than about 4.5, more preferably about 4.3, to prevent microbial growth.

Acidic pH adjusting agents suitable for positioning the pH of the biocide within the above acidic ranges preferably include organic acids, and still more preferably fatty acids. The fatty acid may be saturated or unsaturated, straight, branched, or cyclic. Mixtures of fatty acids may be used. The fatty acids preferably are C₆ to C₁₈ fatty acids, more preferably C₁₀ to C₁₂. Representative fatty acids include decanoic (capric) acid, undecanoic acid, and dodecanoic (lauric) acid, hexadecanoic (palmitic) acid, and octadecanoic (stearic) acid. Other pH adjusting agents include organic acids such as salicylic acids, ascorbic acid, malic acid, citric acid anhydride, fumaric acid, acetic acid, lactic acid, and succinic acid, as well as non-organic acids, e.g., buffered phosphoric acid. Commercial sources of organic acids include CBI Laboratories, Inc. of Ft. Worth, Tex. and First City Chemical, Inc. of Garland, Tex. Commercial sources of citric acid anhydride include UNIVAR, Inc. of Seattle, Wash. and CBI Laboratories, Inc. of Ft. Worth, Tex. The pH adjusting agent is used in a sufficient amount to obtain the desired pH. Usually, about 0.1 weight percent to about 3.0 weight percent of the pH adjusting agent will suffice.

It has also been found that the biocide will operate effectively if made and stored in an alkaline pH range of about 8.5 to about 9.5, more preferably about 9.0 to about 9.5. Use of a pH greater than about 9.5 is discouraged because the enzymes and amino acids of the biocide may denature under severe alkaline conditions. Suitable pH adjusting agents for placing the pH of the biocide in the above alkaline ranges include, for example, sodium hydroxide, potassium hydroxide, and a combination thereof. A pH below about 8.5, and more particularly between about 4.3 and about 8.5, favors bacterial and fungal growth and is therefore less desired.

The biocide composition embodied herein may contain one or more additional components such as additional enzymes, enzyme blends, defoamers, corrosion inhibitors, dyes, fragrances, hydrotropes, suspending agents (e.g., propylene glycol), hydrophobic dispersants/cleaning agents (e.g., delimonene, turpines available from CBI. Laboratories of Ft. Worth Tex. and Athea Laboratory, Inc. of Milwaukee, Wis.), coloring agents, odor neutralizers, buffers, and others compatible with the composition.

Without wishing to be bound by theory, it is believed that the enzymes present in the biocide composition break down the polysaccharide/amino acid/lipid cell wall or membrane of an offending bacteria, fungus, mycelium, spore, or other microorganism (e.g., Aspergillus spp, Penicillium spp, Cladosporium, E Coli, Pseudomonas spp, Staphylococcus aureus, Aspergillus spp, etc.), and neutralize the same via a lysing mechanism. Preferably, the enzyme comprises one or more members selected from amylase, lipase, cellulase, and protease. When protease is selected, it is preferably used in combination with lipase. Other enzymes, such as carboxypeptidase, may be employed for use alone or in combination with the above enzymes, e.g., to enhance the enzymatic efficacy of the formulation. In an especially preferred embodiment, the biocide includes amylase, lipase, cellulose, and protease.

The selected concentration of enzymes in the solution may be influenced by various factors, including the activity of the enzymes, the severity of the infestation to be treated, and the intended environment in which the biocide will be used. Generally, the enzymes should be present in the biocide in a concentration of at least 0.01 weight percent of the total composition weight. Preferably, the enzyme concentration in the composition is selected in a range of about 0.1 weight percent to about 10 weight percent, such as in a range of 0.1 weight percent to 5.0 weight percent. The biocide may have, for example, a proteolytic activity between about 100 and 1,000 GU/gram, a lipolic activity between about 50 and 1,000 LU/gram, an amylotic activity between about 50 and 1,000 MU/gram, and a cellulolytic activity between about 100 and about 1,000 CU/gram, although it is within the scope of the invention to employ lower or higher activities. Typically, commercial suppliers will report the activity of their enzymes. Alternatively, the enzyme activity may be determined using established methods. High activities of enzyme concentrates available from commercial sources may be diluted for use in the biocide.

Additional enzymes added to the composition may be of any suitable natural or synthetic origin, such as vegetable, animal, bacterial, fungal and yeast origin, although biologically derived bacterial and fungal origin enzymes are particularly preferred. Purified or non-purified forms of these enzymes may be used. In accordance with common practice, wild-type enzymes derived from pure cultures may be modified via protein genetic engineering techniques in order to optimize their performance efficiency for the compositions and methods of the invention. For example, the variants may be designed such that the compatibility of the enzyme(s) with other ingredients of the composition is increased. Alternatively, the variant may be designed such that the optimal pH, stability, catalytic activity and the like, of the enzyme variant is tailored to suit the particular cleaning application.

Proteases are effective in hydrolyzing or breaking down proteins, particularly animal proteins. Proteases useful for the purposes of the present invention may be derived from a variety of sources, including microorganisms such as those of genus Aspergillus and Bacillus. Particularly useful proteases include those of fungi origin Aspergillus oryzae and Aspergillus niger and bacteria origin Bacillus subtilis and Bacillus licheniformis. Amylases are carbohydrate-hydrolyzing enzymes effective in breaking down starches into sugars. Useful amylases may be obtained from a wide variety of sources, including, for example, Aspergillus and Bacillus microorganisms such as Aspergillus oryzae and Bacillus subtilis, respectively. Lipase is a glyceride-hydrolyzing enzyme capable of breaking down a broad range of fat, grease, oil, and other hydrophobic material. Lipases may be prepared, for example, from certain fungi, such as Rhizopus oryzae. The lipase also serves to remove non-organic contaminants from the building surface. Cellulases are cellulose-hydrolyzing enzymes. Cellulases include one or more subcategories of enzymes which hydrolyze subcategories of cellulose, such as endocellulases, exocellulases, beta-1,3-glucanases, and beta-glucosidases. Preferred cellulases may be prepared, for example, from fungi, such as Trichoderma longibrachiatum and Aspergillus niger. Commercial sources of biologically derived enzymes are well known in the art, and include, for example, Bio-Cat, Inc. of Troy, Va., Deerland Chemical, Deerland Enzymes, Inc. of Kennesaw, Ga., and Medipharm USA of Des Moines, Iowa. Plant-based enzymes may be obtained from well known sources, such as Coats Aloe International, Inc.

According to another embodiment of the invention, the botanical extract is replaced in whole or part with one or more alternative sources of enzymes, amino acids, mucilaginous polysaccharides, and penetrants. The source(s) of one or more of the above substitute ingredients optionally may be derived from botanical extracts.

Mucilaginous polysaccharides have biological and physical properties that make them useful in a variety of applications as ingredients of cosmetic, beverage, and pharmaceutical formulations and viscosifiers in chemical production processes. For the purposes of this embodiment, mucilaginous polysaccharides are generally meant to include mucilaginous polysaccharide biopolymers characterized by hetero or polysaccharide chains, either linear or branched, having acetyl, nitrogen acetyl, or other nitrogen functional groups associated with the main polysaccharide chain, and containing protein chemically bound to one or more of the external hydroxyl (—OH) groups of the main structure of the polysaccharide chains. Alternative sources include, for example, any plant (e.g., Plantago ovata, Plantago major) and cultured microorganisms (e.g., Coriolus versicolor, Shiitake, Maitake) containing mucilaginous polysaccharides. A description of mucilaginous polysaccharides and methods of isolating the same is provided in U.S. Pat. No. 6,482,942, which is incorporated herein by reference. Preferably, the mucilaginous polysaccharides constitute about 0.005 to about 3.0 weight percent of the composition of this embodiment.

Lignin is one of the most abundant organic materials in nature and is the so-called “glue” in the cellulosic skeleton, which provides strength and support to trees and other plants. Lignin is also a major by-product of wood pulp processing in mills and, as such, is widely available. There are various lignin compounds that may be suitable for use with this embodiment, including lignosulphonates, Kraft lignins, oxylignins, and combinations and derivatives thereof. An example of a commercially available Kraft lignin is sold as INDULIN AT™. It is preferred that the lignin compounds constitute less than about 1 weight percent, more preferably about 0.001 to about 0.01 weight percent of the composition of this embodiment.

Alternative amino acid sources are plentiful, and may include, for example, soy protein oil and processed oats. Examples of amino acids that may be used include arginine, cystine, glycine, histidine, isoleucine, leucine, lysine, methionine, phenylalanine, threonine, typtophan, tyrosine, valine, serine, aspartic acid, and glutamic acid. Commercial suppliers of amino acid sources include SoLae, Inc. of Decatur, Ill. and NutriCepts, Inc. of Burnsville, Minn.

The above-embodied compositions are in their preferred form comprised of a combination of safe, generally non-toxic organic enzymes and other components using natural, plant-derived enzymes and/or enzymes derived from fungi or bacteria. Without wishing to be bound by theory, it is believed that the embodied compositions break down polysaccharide cell walls, after which the enzymes destroy and neutralize the protein content of the offending fungi, bacteria, spores, and mycelium as well as any extracellular surface proteins, on contact. The above-embodied compositions are in their preferred form capable of penetrating beneath the surface of a porous material, such as of concrete, through diffusion and/or a capillary mode of action, leaving behind a surface residue on the surface and throughout the pores. Again without wishing to be bound by any theory, it is believed that this residue protects the building materials from microbial re-growth and spore germination.

An embodiment of a method of making the building surface treatment biocide will now be described in detail. It should be understood that the embodiment described below may be modified and changed, and further that many additional methods exist and may be employed for making the inventive composition.

The sequence of adding the constituents or ingredients to one another may vary. However, there are several procedures and conditions that optionally yet preferably are practiced in carrying out the method.

It is preferred to establish the nonionic surfactant at the desired pH range, such as by the addition of fatty acids, prior to introducing the aloe and enzyme/enzyme blend into the composition. The nonionic surfactant is preferably mixed with other optional ingredients, such as emulsifiers, cleaning agents, and suspending agents prior to the introduction of the botanical extract and enzyme(s).

It is preferred to combine the extract with an antimicrobial agent, such as potassium sorbate and/or sodium benzoate, prior to combining the extract with the enzymes. Similarly, added enzymes preferably are provided in distilled, demineralized water that has been steam processed, pure, and contains no mineral ions, such as calcium minerals, or ionic exchange components capable of denaturing the proteins in solution. The enzymes are preferably dispersed in aseptic water, more preferably containing a preservative such as Kathon CG. Another preference is to maintain the botanical extract and optional added enzymes at a temperature below about 90° F.

The use of cold processing to blend the liquid solution with the enzymes, plant-based materials, amino acids, and mucilaginous polysaccharides increases the efficacy of the formulation and helps stabilize the proteins. Heating these components above approximately 150° F. for more than about 45 minutes may destroy or denature the enzymes.

The biocide composition preferably is free of alcohols and other ingredients that denature proteins and enzymes. The biocide composition also preferably is free of active biologicals, including gram positive bacteria, such as Bacillus subtilis and fungi such as Aspergillus oryzae and Aspergillus niger.

Prior to its use, the building surface treatment biocide is preferably stored and transported under moderate conditions, preferably within a temperature range of about 32° F. to 100° F., preferably about 45° F. to about 90° F. Also, the biocide preferably is contained in a relatively non-humid environment, and still more preferably is placed in hermetically sealed, insulated containers.

Another embodiment of the invention involves a method for the treatment of a building surface against fungal and bacterial growth, spore germination and mycelium growth. The treatment method extends to the removal, prevention, reduction, and/or resistance to recurrence of microbial growth in places of work and habitation, including but not necessarily limited to residential dwellings, apartments, condominiums, commercial properties, loading docks, offices, modular buildings, transportation systems (e.g., metros, airports, bus stations), and industrial workplaces. The treatment method also may be applied to maritime and aviation vessels containing living quarters, such as in the case of a cruise ship. Various surfaces can be treated using the method and composition of the present invention, including by way of example, the following: metal surfaces, such as steel, aluminum and aluminum alloys, copper and copper alloys, zinc and zinc alloys; plastics, such as polycarbonates, polyvinyl chlorides, polyurethanes, polyolefins, epoxides, nylons; and other non-metal surfaces, such as wood, ceramics, glass, concrete, and the like. Specific examples of building materials that may be treated in accordance with this embodiment include, not necessarily by limitation, wall board, ventilation and air handling surface areas, AC coils, sub flooring, wood paneling, brick, concrete, OSB board, carpeting, sheetrock, and the like.

Generally, the method involves contacting a building surface with an effective amount of the building surface treatment biocide to treat microbial growth. It is within the scope of the invention to apply the building surface treatment biocide to a finished structure or a structure under construction. The biocide is useful in the treatment of infected surfaces and the preventative treatment of non-infected surfaces to avoid or suppress future infection. The biocide is especially useful for preventative treatment of a building under construction, when it is easy to access and pre-treat surface areas to be hidden in the finished building, such as areas behind wallboards and sheetrock and within vents. The biocide may be applied to the surface in any known or suitable manner, including using application techniques such as spraying, atomizing, coating, immersion, immersion ultrasonic, dipping, etc. In a typical application approximately 4 liters of product is required to treat a 1,000 square foot area.

According to an embodiment of the invention, a standard spray application technique is employed to apply a liquid spray of the building surface treatment biocide to the building surface. Standard spray equipment may be used. Preferably, the liquid spray primarily includes particles greater than fifteen (15) microns in size to prevent the occurrence of bacteria and fungi growth and spore germination. According to another embodiment, an atomization fumigation technique is employed for application of the biocide. The atomization fumigation application involves misting the biocide into particles of about 7 microns to about 15 microns in size and contacting the particles against a building surface. Commercial equipment may be used for spraying or atomizing the biocide on a building surface. Especially useful examples of commercial equipment include the Model 7808 NOZ-L-JET atomizer of Fogmasters, Inc. of Deerfield Beach, Fla. and the 534 Specialty Fogger/atomizer of Lafferty Equipment Manufacturing, Inc. of North Little Rock, Ark. The equipment preferably does not contain copper and/or brass components that come into contact with and denature the biocide. Such components may be replaced with stainless steel, polytetrafluoroethylene, or polyvinylchloride. According to one preferred embodiment, the composition is applied via atomization up to 15 to 20 feet away from the building material.

The contact time between the biocide and the surface to be cleaned is preferably at least 24 hours, more preferably about 24 hours to about 48 hours, although shorter or longer contact times may be selected. The contact time will depend upon several interdependent variables, including the amount and type of fungus and other contamination on the surface to be cleaned, the material composing and porosity of the surface, and the effectiveness of the particular application technique and equipment employed. Removal of the biocide following the contact period can be accomplished using known techniques, such as rinsing with water. Treatment may be repeated if desired or necessary. Further, the embodied treatment may be combined with other products and agents. For example, the surface may be pretreated, if desired, to remove excess grime and soil prior to application of the inventive biocide. Optionally, the surface may be subjected to pre-treatment or post-treatment procedures, or further treated with another antimicrobial or cleaning product prior or subsequent to removal of the biocide. Multiple different biocide compositions may be applied simultaneously or consecutively.

The standard spray and atomization application embodiments have been found in practice to substantially improve the condition of building materials, exposed surface areas, and indoor air quality. It is believed that the significant improvements attributable to these application techniques will, over an extended period of time, likely provide consistent and reliable improvements in indoor air quality, and a corresponding reduction in human health risks and experiences that would otherwise have been recorded through harmful bacteria and fungi exposure.

### EXAMPLES

Examples of building surface treatment biocide and method of making the same will now be described in detail. It should be understood that many methods exist for making the inventive composition, and that the following are exemplary, but not exhaustive descriptions.

### Example 1

A dry enzyme blend having the composition set forth in Table 1 was hydrolyzed in distilled water to provide a solution of 2 weight percent enzyme blend in water.

TABLE 1

| | Type | | | | | |
|---|---|---|---|---|---|---|
| Enzyme | Derived | Source | Units (gram⁻¹) | | Units (mL⁻¹) | |
| Amylase | Bacterial | Bacillus subtilis | 4,200 | BAU/gram | 87.4 | BAU/mL |
| Amylase | Fungal | Aspergillus oryzae | 1,400 | SKB/gram | 29.1 | SKB/mL |
| Protease | Bacterial | Bacillus subtilis, | 5,600 | PC/gram | 116.5 | PC/mL |
| | | Bacillus licheniformis | | | | |
| Protease | Fungal | Aspergillus oryzae, | 7,000 | HUT/gram | 145.6 | HUT/mL |
| | | Aspergillus niger | | | | |
| Lipase | Fungal | Rhizopus oryzae | 2,100 | FIP/gram | 43.7 | FIP/mL |
| Cellulase | Fungal | Trichoderma | 2,100 | CU/gram | 43.7 | CU/mL |
| | | longibrachiatum | | | | |
| Cellulase | Fungal | Aspergillus niger | 700 | CU/gram | 14.7 | CU/mL |

A building surface treatment biocide according to an embodiment of the invention was then prepared to have the composition set forth in Table 2 below.

TABLE 2

| | | | | |
|---|---|---|---|---|
| | | | | Range |
| Phase | Ingredient | Function | pbw | (+/−) |

Initial Temperature 40° C. +/− 4° C.

| | | | | |
|---|---|---|---|---|
| 1 | Polysorbate-20 | Nonionic surfactant | 12.50 | 2.00 |
| 1 | Polysorbate-80 | Nonionic surfactant | 12.50 | 2.00 |
| 1 | Scorbic/Ascorbic Acid | pH Adjuster | 2.00 | 0.50 |
| 1 | Undecylenic acid | pH Adjuster | 1.50 | 0.05 |
| 1 | Delimonene | Cleaning agent | 4.00 | 3.25 |
| 1 | Cupl-Pic (PPG-2 | Emulsifier | 5.00 | 1.00 |
| | iosceteht-20-acetate) | | | |
| 1 | Methylparaben | Preservative | 2.00 | 0.25 |
| 1 | Propylparaben | Preservative | 1.00 | 0.40 |
| 1 | Propylene Glycol | Suspending Agent | 10.00 | 2.00 |

Adjusted Temperature to 32.2° C. +/− 1° C.

| | | | | |
|---|---|---|---|---|
| | Citric Acid Anhydrous | pH Adjuster to | N/A | N/A |
| | | pH = 3.8 | | |
| 2 | Aloe barbadensis | Mucilage, amino acids | 8.00 | 2.00 |
| | | mucopolysaccharides, | | |
| | | lignins | | |
| 2 | Potassium phosphate | Aloe Preservative | 0.125 | 0.05 |
| 3 | Enzyme blend | Active Agent | 2.50 | 0.025 |
| 3 | Distilled Water | | 37.00 | 5.00 |
| 3 | Kathon CG | Preservative | 0.20 | 0.05 |

The surfactants, emulsifiers, organic acids, preservatives and other phase 1 ingredients were combined together at 40° C.±4° C. The organic acids were used to adjust the pH to 3.2 to 4.5. The solution was allowed to cool to 32.2° C., and the pH of the solution was adjusted to 3.8 (+/−0.3) with citric acid anhydrous. In phase 2, Aloe barbadensis (28×/40× polysaccharide/amino acids) and an aloe preservative were added. After verifying that the enzyme solution was aseptic and free of gram positive bacteria and fungi, aseptic distilled water and the enzyme solution (22° C.) with Kathon CG were added subsequently in phase 3 to avoid denaturing of proteins, organic acids and amino acids used in the composition. The pH of the final solution was adjusted to 3.8+/−0.5 with acid.

### Examples 2-17

The initial preparation and blending temperature of the liquid solutions was 40° C. (104° F.). Surfactants, limonenes, turpines cleaners, organic acids, preservatives, emulsifiers, and/or stabilizers were added in phase 1 in the proportions (by weight) specified in Tables 3 and 4. The phase 1 ingredients were blended, and held for one to two hours, and allowed to cool to 32° C. (90° F.). The solution pH was adjusted where indicated with citric acid. In phase 2, the aloe and preservatives, if any, were added. In phase 3, a 22-25° C. solution of aseptic, mineral-free distilled water, enzymes and optionally Kathon preservative was added to the liquid solution of phases 1 and 2. The solution pH was then lowered with citric acid or raised into the alkaline range with sodium/potassium hydroxide.

TABLE 3

| | 2 | 3 | 4 | 5 | 6 | 7 | 8 |
|---|---|---|---|---|---|---|---|
| Polysorbate-20 | 21 | 21 | 21 | 20 | 12.5 | 20 | 12.5 |
| Polysorbate 80 | 8 | 8 | 8 | 10 | | | |
| Tween 80 | | | | | | | |
| Polysorbate 40 | | | | | | | |
| Tween 40 | | | | | | | |
| Polysorbate 80 | | | | | 12.5 | 10 | 12.5 |
| Tween 80 | | | | | | | |
| Undecylenic | 1 | 1 | 1 | 1 | 1 | 1 | 1 |
| aid | | | | | | | |
| Scorbic/Ascorbic acid | 2 | 2 | | | | | |
| Decyl | | | | | | | |
| glucoside | | | | | | | |
| Sodium lauryl | | | | | | | |
| sulfate | | | | | | | |
| Delimonene | 3 | 3 | 4 | 7 | 4 | 6 | 4 |
| Methyl | 2 | 2 | 2 | 2 | 2 | 2 | 2 |
| paraben | | | | | | | |
| Propyl paraben | 1 | 1 | | | 1 | | |
| Propylene | 20 | 20 | 20 | 10 | 10 | 20 | 10 |
| glycol | | | | | | | |
| Phase 2 pH | 3.8 ± .3 | 3.9 ± .6 | 3.8 ± .6 | 3.8 ± .6 | | | |
| Aloe | 10 | 10 | 10 | 12 | 15 | 10 | 16 |
| barbadensis | | | | | | | |
| Potassium | 1 | 1 | 1 | 1 | 1 | 1 | 1 |
| sorbate | | | | | | | |
| Sodium | 1 | 1 | 1 | 1 | 1 | 1 | 1 |
| benzoate | | | | | | | |

Phase 3

| | | | | | | | |
|---|---|---|---|---|---|---|---|
| Distilled Water | 28 | 28 | 27 | 26 | 35 | 29 | 30 |
| Enzymes | 2 | 2 | 2 | | 5 | | 10 |
| Kathon CG | 0.001 | 0.001 | 0.001 | 0.001 | 0.001 | 0.001 | 0.001 |
| Final pH | 3.9 ± .6 | 3.8 ± .6 | 3.8 ± .6 | 3.8 ± .6 | 9.3 ± .2 | 9.3 ± .2 | 9.3 ± .2 |

TABLE 4

| | 9 | 10 | 11 | 12 | 13 | 14 | 15 | 16 | 17 |
|---|---|---|---|---|---|---|---|---|---|
| Polysorbate-20 | 10 | 10 | 12.5 | 12.5 | 15 | | 15 | 15 | 15 |
| Polysorbate 80 | | | | 12.5 | 15 | | 15 | 15 | 15 |
| Tween 80 | | | | | | | | | |
| Polysorbate 40 | | | | | | | | | |
| Tween 40 | | | | | | | | | |
| Polysorbate 80 | 10 | 10 | 12.5 | | | | | | |
| Tween 80 | | | | | | | | | |
| Undecylenic | | | | | 1 | | 1 | 1 | |
| aid | | | | | | | | | |
| Decyl | | | 4 | | | | | | |
| glucoside | | | | | | | | | |
| Sodium lauryl | | | 10 | | | | | | |
| sulfate | | | | | | | | | |
| Delimonene | 5 | 10 | 6 | 1 | 2 | | 1 | 2 | 5 |
| Lemon Grass | | 3 | | | | | | | |
| Oil | | | | | | | | | |
| Methyl | | | 2 | 2 | 2 | | | | |
| paraben | | | | | | | | | |
| Propyl paraben | | | 1 | 1 | 1 | | | | |
| Cupl-Pic | 10 | 10 | | | | | | | |
| Propylene | 32 | 32 | 20 | | | | | | |
| glycol | | | | | | | | | |
| Phase 2 pH | 3.9 ± .6 | 3.9 ± .6 | 3.8 ± .3 | 3.8 ± .3 | 3.8 ± .3 | | 3.8 ± .3 | 3.8 ± .3 | 3.8 ± .3 |
| Aloe | 24 | 23 | 20 | 5 | 5 | 98 | 5 | | 6 |
| barbadensis | | | | | | | | | |
| Potassium | | 1 | 1 | 1 | 1 | 1 | 1 | 1 | 1 |
| sorbate | | | | | | | | | |
| Sodium | | 1 | 1 | 1 | 1 | 1 | 1 | 1 | 1 |
| benzoate | | | | | | | | | |
| Distilled Water | 8 | | 10 | 59 | 52 | | 59 | 55 | 57 |
| Enzymes | | | | 5 | 5 | | 2 | 5 | |
| Kathon CG | 0.001 | 0.001 | 0.001 | | | | | | |
| Final pH | 3.9 ± .5 | 3.9 ± .6 | 3.9 ± .5 | 9.7 ± .3 | 3.8 ± .5 | 4.0 ± .3 | 3.8 ± .4 | 3.8 ± .5 | |

The biocides of Examples 2-8 were then tested as follows.

Pure cultures of the microorganisms Escherichia coli (ATCC No. 8739, Quality Technologies, Inc.), Staphylococcus aureus (ATCC No. 6538, Quality Technologies, Inc.), Aspergillus niger (ATCC No. 16404, Quality Technologies, Inc), and Penicillium spp. were maintained as stock cultures from which working inocula were prepared. The viable microorganisms used were not more than five passages removed from the original stock culture, wherein one passage is defined as the transfer of organisms from an established culture to fresh medium.

A. Preparation of Inoculum:
1. Inoculate the surface of a suitable volume of solid agar medium from a recently grown stock culture of each of the microorganisms. Incubate the bacterial cultures at 35° C.+/−2° C. for 4-6 days.
2. Determine the number of viable microorganisms in each milliliter of the inoculum suspensions by serial dilution in sterile phosphate buffered saline.
3. Plate dilutions of 10⁻⁶, 10⁻⁷, and 10⁻⁸ for test organisms.
4. Overlay lecithin (7 grams per 1,000 ml) and Tween 80 (5 grams per 1,000 ml) with approximately 20 ml of 45° C. tryptic soy agar.
5. Incubate for 48-96 hours at 35° C.+/−2° C. for the aerobic organisms.
6. Count test organisms.
7. Calculate the number of organisms as colony forming units per ml (cfu/ml) of inoculum as follows:

$$\frac{cfu / ml ( 0.1 ml )}{9.9 ml} = cfu / ml of product$$

B. Preparation of Test Samples
1. Accurately pipette 9.9 ml of product into an appropriately labeled or coded test tube.
2. Store test samples at ambient room temperature.

C. Inoculation of Plating of Samples
1. Aseptically transfer 0.1 ml of the test organism into an appropriate labeled 9.9 ml sample of test material. The test organism was inoculated as a pure culture into a single 9.9 ml sample of test material.
2. Thoroughly mix or stir all samples.
3. Allow the samples to stand for twenty-four (24) hours and forty-eight (48) hours.
4. Remove one milliliter aliquots at the indicated times and transfer to 9.0 ml sterile saline.
5. Perform serial dilutions from 10⁻¹ to 10⁻⁵.
6. Transfer 1.0 ml of each dilution into a 100×15 mm Petri plate.
7. Overlay lecithin (7 grams per 1000 ml) and Tween 80 (5 grams per 1000 ml) with approximately 20 ml of 45° C. tryptic soy agar.
8. Gently swirl plates and allow to solidify.
9. Incubate plates for 48-96 hours at 35° C.+/−2° C.

D. Sample Evaluation
1. Read plates and record results on appropriate data sheet.
2. Using the calculated inoculum concentration for each test microorganism, calculate the log reduction for each microorganism to determine kill rate.

The kill rate results were as follows:

TABLE 5

| | Exam- | t | T | Inoculum | Average | Log |
|---|---|---|---|---|---|---|
| Organism | ple | (hr) | (° C.) | level | Growth | Reduction |
| E. Coli | 2 | 24 | 22.2 | 6.31 × 10⁵ | None | 5.80 |
| S. aureus | 2 | 24 | 22.2 | 4.55 × 10⁵ | None | 5.67 |
| A. niger | 2 | 24 | 22.2 | 3.76 × 10⁵ | None | 5.58 |
| Penicillium | 2 | 24 | 22.2 | 5.56 × 10⁵ | None | 5.75 |
| E. Coli | 2 | 48 | 22.2 | 6.31 × 10⁵ | None | 5.80 |
| S. aureus | 2 | 48 | 22.2 | 4.55 × 10⁵ | None | 5.67 |
| A. niger | 2 | 48 | 22.2 | 3.76 × 10⁵ | None | 5.58 |
| Penicillium | 2 | 48 | 22.2 | 5.56 × 10⁵ | None | 5.75 |
| E. Coli | 3 | 24 | 22.2 | 6.31 × 10⁵ | None | 5.80 |
| S. aureus | 3 | 24 | 22.2 | 4.55 × 10⁵ | None | 5.67 |
| A. niger | 3 | 24 | 22.2 | 3.76 × 10⁵ | None | 5.58 |
| Penicillium | 3 | 24 | 22.2 | 5.56 × 10⁵ | None | 5.75 |
| E. Coli | 3 | 48 | 22.2 | 6.31 × 10⁵ | None | 5.80 |
| S. aureus | 3 | 48 | 22.2 | 4.55 × 10⁵ | None | 5.67 |
| A. niger | 3 | 48 | 22.2 | 3.76 × 10⁵ | None | 5.58 |
| Penicillium | 3 | 48 | 22.2 | 5.56 × 10⁵ | None | 5.75 |
| E. Coli | 4 | 24 | 22.2 | 6.31 × 10⁵ | None | 5.80 |
| S. aureus | 4 | 24 | 22.2 | 4.55 × 10⁵ | None | 5.67 |
| A. niger | 4 | 24 | 22.2 | 3.76 × 10⁵ | None | 5.58 |
| Penicillium | 4 | 24 | 22.2 | 5.56 × 10⁵ | None | 5.75 |
| E. Coli | 4 | 48 | 22.2 | 6.31 × 10⁵ | None | 5.80 |
| S. aureus | 4 | 48 | 22.2 | 4.55 × 10⁵ | None | 5.67 |
| A. niger | 4 | 48 | 22.2 | 3.76 × 10⁵ | None | 5.58 |
| Penicillium | 4 | 48 | 22.2 | 5.56 × 10⁵ | None | 5.75 |
| E. Coli | 5 | 24 | 22.2 | 6.31 × 10⁵ | None | 5.80 |
| S. aureus | 5 | 24 | 22.2 | 4.55 × 10⁵ | None | 5.67 |
| A. niger | 5 | 24 | 22.2 | 3.76 × 10⁵ | None | 5.58 |
| Penicillium | 5 | 24 | 22.2 | 5.56 × 10⁵ | None | 5.75 |
| E. Coli | 5 | 48 | 22.2 | 6.31 × 10⁵ | None | 5.80 |
| S. aureus | 5 | 48 | 22.22 | 4.55 × 10⁵ | None | 5.67 |
| A. niger | 5 | 48 | 22.2 | 3.76 × 10⁵ | None | 5.58 |
| Penicillium | 5 | 48 | 22.2 | 5.56 × 10⁵ | None | 5.75 |
| E. Coli | 6 | 24 | 22.2 | 6.31 × 10⁵ | None | 5.80 |
| S. aureus | 6 | 24 | 22.2 | 4.55 × 10⁵ | None | 5.67 |
| A. niger | 6 | 24 | 22.2 | 3.76 × 10⁵ | None | 5.58 |
| Penicillium | 6 | 24 | 22.2 | 5.56 × 10⁵ | None | 5.75 |
| E. Coli | 6 | 48 | 22.2 | 6.31 × 10⁵ | None | 5.80 |
| S. aureus | 6 | 48 | 22.2 | 4.55 × 10⁵ | None | 5.67 |
| A. niger | 6 | 48 | 22.2 | 3.76 × 10⁵ | None | 5.58 |
| Penicillium | 6 | 48 | 22.2 | 5.56 × 10⁵ | None | 5.75 |
| E. Coli | 7 | 24 | 22.2 | 6.31 × 10⁵ | None | 5.80 |
| S. aureus | 7 | 24 | 22.2 | 4.55 × 10⁵ | None | 5.67 |
| A. niger | 7 | 24 | 22.2 | 3.76 × 10⁵ | 7.70 × 10⁴ | 0.69 |
| Penicillium | 7 | 24 | 22.2 | 5.56 × 10⁵ | None | 5.75 |
| E. Coli | 7 | 48 | 22.2 | 6.31 × 10⁵ | None | 5.80 |
| S. aureus | 7 | 48 | 22.2 | 4.55 × 10⁵ | None | 5.67 |
| A. niger | 7 | 48 | 22.2 | 3.76 × 10⁵ | 4.15 × 10⁴ | 0.96 |
| Penicillium | 7 | 48 | 22.2 | 5.56 × 10⁵ | None | 5.75 |
| E. Coli | 8 | 24 | 22.1 | 6.31 × 10⁵ | None | 5.80 |
| S. aureus | 8 | 24 | 22.1 | 4.55 × 10⁵ | None | 5.67 |
| A. niger | 8 | 24 | 22.1 | 3.76 × 10⁵ | None | 5.58 |
| Penicillium | 8 | 24 | 22.1 | 5.56 × 10⁵ | None | 5.75 |
| E. Coli | 8 | 48 | 22.1 | 6.31 × 10⁵ | None | 5.80 |
| S. aureus | 8 | 48 | 22.1 | 4.55 × 10⁵ | None | 5.67 |
| A. niger | 8 | 48 | 22.1 | 3.76 × 10⁵ | None | 5.58 |
| Penicillium | 8 | 48 | 22.1 | 5.56 × 10⁵ | None | 5.75 |

Each of the Examples 2-8 tested very effective in reduction of the fungi and bacteria tested. In all but one instance, the kill rate exceeded a 5 log reduction, which far surpassed the goal of a 2-log reduction.

Examples 9-14 were tested using the same procedures set forth above.

The kill rate results were as follows:

TABLE 6

| | Ex- | | | | | | Log |
|---|---|---|---|---|---|---|---|
| | am- | t | | T | Inoculum | Average | Reduc- |
| Organism | ples | (hr) | pH | (° C.) | level | Growth | tion |
| A. niger | 9 | 24 | 3.32 | 22.5 | 3.76 × 10⁵ | None | 5.58 |
| Penicillium | 9 | 24 | 3.32 | 22.5 | 5.56 × 10⁵ | None | 5.75 |
| A. niger | 9 | 48 | 3.32 | 22.5 | 3.76 × 10⁵ | None | 5.58 |
| Penicillium | 9 | 48 | 3.32 | 22.5 | 5.56 × 10⁵ | None | 5.75 |
| A. niger | 10 | 24 | 4.32 | 22.1 | 3.76 × 10⁵ | None | 5.58 |
| Penicillium | 10 | 24 | 4.32 | 22.1 | 5.56 × 10⁵ | None | 5.75 |
| A. niger | 10 | 48 | 4.32 | 22.1 | 3.76 × 10⁵ | None | 5.58 |
| Penicillium | 10 | 48 | 4.32 | 22.1 | 5.56 × 10⁵ | None | 5.75 |
| A. niger | 11 | 24 | 4.55 | 22.1 | 3.76 × 10⁵ | None | 5.58 |
| Penicillium | 11 | 24 | 4.55 | 22.1 | 5.56 × 10⁵ | None | 5.75 |
| A. niger | 11 | 48 | 4.55 | 22.1 | 3.76 × 10⁵ | None | 5.58 |
| Penicillium | 11 | 48 | 4.55 | 22.1 | 5.56 × 10⁵ | None | 5.75 |
| A. niger | 12 | 24 | 9.53 | 22.2 | 3.76 × 10⁵ | 140 | 3.43 |
| Penicillium | 12 | 24 | 9.53 | 22.2 | 5.56 × 10⁵ | None | 5.75 |
| A. niger | 12 | 48 | 9.53 | 22.2 | 3.76 × 10⁵ | None | 5.58 |
| Penicillium | 12 | 48 | 9.53 | 22.2 | 5.56 × 10⁵ | None | 5.75 |
| A. niger | 13 | 24 | 3.05 | 22.2 | 3.76 × 10⁵ | None | 5.58 |
| Penicillium | 13 | 24 | 3.05 | 22.2 | 5.56 × 10⁵ | None | 5.75 |
| A. niger | 13 | 48 | 3.05 | 22.2 | 3.76 × 10⁵ | None | 5.58 |
| Penicillium | 13 | 48 | 3.05 | 22.2 | 5.56 × 10⁵ | None | 5.75 |
| A. niger | 14 | 24 | 4.02 | 22.3 | 3.76 × 10⁵ | 545 | 2.84 |
| Penicillium | 14 | 24 | 4.02 | 22.3 | 5.56 × 10⁵ | None | 5.75 |
| A. niger | 14 | 48 | 4.02 | 22.3 | 3.76 × 10⁵ | None | 5.58 |
| Penicillium | 14 | 48 | 4.02 | 22.3 | 5.56 × 10⁵ | None | 5.75 |

The tests show that each of Examples 9-14 were very effective as a biocide.

Examples 11, 13, and 15-17 were next tested using the following procedures.
A. Preparation of Inoculum:
1. Inoculate the surface of a suitable volume of solid agar medium from a recently grown stock culture of each of the microorganisms. Incubate the fungal cultures at 35° C.+/−2° C. for 4-6 days.
2. To harvest the fungal culture, place a loop full of the microorganism from the plate into a test tube containing sterile phosphate buffered saline and vortex. Adjust the count with sterile saline or additional microorganisms so that the concentration of the inoculum level is between 10⁷ and 10⁸ microorganisms per milliliter of product.
3. Determine the number of viable microorganisms in each milliliter of the inoculum suspensions by serial dilution in sterile phosphate buffered saline.
3. Plate dilutions of 10⁻⁶, 10⁻⁷, and 10⁻⁸ for test organisms.
4. Overlay lecithin (7 grams per liter) and Tween 80 (5 grams per liter) with approximately 20 ml of 45° C. tryptic soy agar.
5. Incubate for 40-48 hours at 35° C.+/−2° C. for the aerobic organisms.
6. Count test organisms.
7. Calculate the number of organisms as colony forming units per ml (cfu/ml) of inoculum as follows:

$$\frac{cfu / ml ( 0.1 ml )}{9.9 ml} = cfu / ml of product$$
B. Preparation of Test Samples: Follow the same procedures above with regard to examples 2-8.
C. Inoculation of Plating of Samples: Follow the same procedures above with regard to examples 2-8, except allow the samples to stand for one (1) hour, twenty-four (24) hours and forty-eight (48) hours. Also, incubate plates for 4-5 days at 35° C.+/−2° C.

D. Sample Evaluation: Follow the same procedures above with regard to examples 2-8.

TABLE 7

| | Exam- | | | Inoculum | Average | Log |
|---|---|---|---|---|---|---|
| Organism | ple | t (hr) | pH | level | Growth | Reduction |
| A. niger | 11 | 1 | 3.34 | 2.18 × 10⁵ | 6.80 × 10⁴ | 0.51 |
| Penicillium | 11 | 1 | 3.34 | 6.50 × 10³ | 75 | 1.94 |
| A. niger | 11 | 24 | 3.34 | 2.18 × 10⁵ | None | 5.34 |
| Penicillium | 11 | 24 | 3.34 | 6.50 × 10³ | None | 3.81 |
| A. niger | 11 | 48 | 3.34 | 2.18 × 10⁵ | None | 5.34 |
| Penicillium | 11 | 48 | 3.34 | 6.50 × 10³ | None | 3.81 |
| A. niger | 13 | 1 | 3.36 | 2.18 × 10⁵ | 1.47 × 10⁵ | 0.17 |
| Penicillium | 13 | 1 | 3.36 | 6.50 × 10³ | 5 | 3.11 |
| A. niger | 13 | 24 | 3.36 | 2.18 × 10⁵ | None | 5.34 |
| Penicillium | 13 | 24 | 3.36 | 6.50 × 10³ | None | 3.81 |
| A. niger | 13 | 48 | 3.36 | 2.18 × 10⁵ | None | 5.34 |
| Penicillium | 13 | 48 | 3.36 | 6.50 × 10³ | None | 3.81 |
| A. niger | 15 | 1 | 3.42 | 2.18 × 10⁵ | 2.61 × 10⁵ | −0.08 |
| Penicillium | 15 | 1 | 3.42 | 6.50 × 10³ | 1.18 × 10⁵ | −1.26 |
| A. niger | 15 | 24 | 3.42 | 2.18 × 10⁵ | 1.49 × 10⁵ | 0.17 |
| Penicillium | 15 | 24 | 3.42 | 6.50 × 10³ | 5.90 × 10⁵ | −0.96 |
| A. niger | 15 | 48 | 3.42 | 2.18 × 10⁵ | 1.51 × 10⁵ | 0.16 |
| Penicillium | 15 | 48 | 3.42 | 6.50 × 10³ | 1.90 × 10⁵ | −0.47 |
| A. niger | 16 | 1 | 3.36 | 2.18 × 10⁵ | 1.51 × 10⁵ | 0.16 |
| Penicillium | 16 | 1 | 3.36 | 6.50 × 10³ | 3.62 × 10⁵ | −1.75 |
| A. niger | 16 | 24 | 3.36 | 2.18 × 10⁵ | 2.95 × 10⁴ | 0.87 |
| Penicillium | 16 | 24 | 3.36 | 6.50 × 10³ | 8.30 × 10⁴ | −1.11 |
| A. niger | 16 | 48 | 3.36 | 2.18 × 10⁵ | 1.76 × 10³ | 2.09 |
| Penicillium | 16 | 48 | 3.36 | 6.50 × 10³ | 2.30 × 10⁴ | −0.55 |
| A. niger | 17 | 1 | 3.66 | 2.18 × 10⁵ | 1.50 × 10⁵ | 0.16 |
| Penicillium | 17 | 1 | 3.66 | 6.50 × 10³ | 3.00 × 10³ | 0.34 |
| A. niger | 17 | 24 | 3.66 | 2.18 × 10⁵ | 8.40 × 10⁴ | 0.41 |
| Penicillium | 17 | 24 | 3.66 | 6.50 × 10³ | None | 3.81 |
| A. niger | 17 | 48 | 3.66 | 2.18 × 10⁵ | 2.70 × 10⁴ | 0.91 |
| Penicillium | 17 | 48 | 3.66 | 6.50 × 10³ | None | 3.81 |

Examples 11 and 13 demonstrated excellent biocide properties. Examples 16-18 were less efficient in their kill rates, likely due to the absence of an antimicrobial agent.

Examples 9, 10, 12, and 14 were next tested using the following procedures.
A. Preparation of Inoculum: Follow the same procedures above with regard to examples 2-8, except (i) the inoculum level was between 10⁶ and 10⁷ microorganisms per milliliter of product, (ii) plate dilutions of 10⁻⁵, 10⁻⁶, and 10⁻⁷ for the test organisms, and (iii) incubate for 48-96 hours.
B. Preparation of Test Samples: Follow the same procedures above with regard to examples 2-8.
C. Inoculation of Plating of Samples: Follow the same procedures above with regard to examples 2-8, except that the inoculum level was between 10⁶ and 10⁷ microorganisms per milliliter of product.

D. Sample Evaluation: Follow the same procedures above with regard to examples 2-8.

TABLE 8

| | Exam- | | | Inoculum | Average | Log |
|---|---|---|---|---|---|---|
| Organism | ple | t (hr) | pH | level | Growth | Reduction |
| A. niger | 9 | 1 | 3.31 | 5.75 × 10⁵ | 1.35 × 10⁵ | 0.63 |
| Penicillium | 9 | 1 | 3.31 | 8.12 × 10⁴ | None | 4.91 |
| A. niger | 9 | 24 | 3.31 | 5.75 × 10⁵ | None | 5.76 |
| Penicillium | 9 | 24 | 3.31 | 8.12 × 10⁴ | None | 4.91 |
| A. niger | 9 | 48 | 3.31 | 5.75 × 10⁵ | None | 5.76 |
| Penicillium | 9 | 48 | 3.31 | 8.12 × 10⁴ | None | 4.91 |
| A. niger | 10 | 1 | 4.37 | 5.75 × 10⁵ | 9.95 × 10⁴ | 0.76 |
| Penicillium | 10 | 1 | 4.37 | 8.12 × 10⁴ | 4.50 × 10³ | 1.26 |
| A. niger | 10 | 24 | 4.37 | 5.75 × 10⁵ | 20 | 4.46 |
| Penicillium | 10 | 24 | 4.37 | 8.12 × 10⁴ | None | 4.91 |
| A. niger | 10 | 48 | 4.37 | 5.75 × 10⁵ | None | 5.76 |
| Penicillium | 10 | 48 | 4.37 | 8.12 × 10⁴ | None | 4.91 |
| A. niger | 12 | 1 | 9.66 | 5.75 × 10⁵ | 1.22 × 10⁵ | 0.67 |
| Penicillium | 12 | 1 | 9.66 | 8.12 × 10⁴ | None | 4.91 |
| A. niger | 12 | 24 | 9.66 | 5.75 × 10⁵ | None | 5.76 |
| Penicillium | 12 | 24 | 9.66 | 8.12 × 10⁴ | None | 4.91 |
| A. niger | 12 | 48 | 9.66 | 5.75 × 10⁵ | None | 5.76 |
| Penicillium | 12 | 48 | 9.66 | 8.12 × 10⁴ | None | 4.91 |
| A. niger | 14 | 1 | 4.01 | 5.75 × 10⁵ | 1.57 × 10⁵ | 0.56 |
| Penicillium | 14 | 1 | 4.01 | 8.12 × 10⁴ | 1.33 × 10⁵ | −0.21 |
| A. niger | 14 | 24 | 4.01 | 5.75 × 10⁵ | 600 | 2.98 |
| Penicillium | 14 | 24 | 4.01 | 8.12 × 10⁴ | None | 4.91 |
| A. niger | 14 | 48 | 4.01 | 5.75 × 10⁵ | None | 5.76 |
| Penicillium | 14 | 48 | 4.01 | 8.12 × 10⁴ | None | 4.91 |

The results show effective kill rates.

The foregoing detailed description of the certain preferred embodiments of the invention has been provided for the purpose of explaining the principles of the invention and its practical application, thereby enabling others skilled in the art to understand the invention for various embodiments and with various modifications as are suited to the particular use contemplated. This description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A building surface treatment biocide, comprising:
a nonionic surfactant;
an antimicrobial agent; and
an botanical extract from a plant selected from the Liliaceae and Cactus families, the extract retaining active enzymes and amino acids of the plant.

2. The building surface treatment biocide of claim 1, further comprising a pH adjusting agent present in an effective amount to establish the building surface treatment biocide at a pH in a range of about 3.1 to about 4.5.

3. The building surface treatment biocide of claim 2, wherein the pH adjusting agent comprises a fatty acid.

4. The building surface treatment biocide of claim 1, further comprising a biologically derived enzyme selected from the group consisting of protease, amylase, lipase, cellulase, and combinations thereof.

5. The building surface treatment biocide of claim 1, wherein the nonionic surfactant comprises a polyoxyethylene sorbitan fatty acid ester.

6. The building surface treatment biocide of claim 1, wherein the antimicrobial agent comprises an isothiazolin compound.

7. The building surface treatment biocide of claim 1, wherein the botanical extract comprises an aloe.

8. The building surface treatment biocide of claim 7, wherein the aloe comprises Aloe barbadensis.

9. The building surface treatment biocide of claim 2, wherein:
the nonionic surfactant comprises a polyoxyethylene sorbitan fatty acid ester;
the antimicrobial agent comprises an isothiazolin compound;
the botanical extract comprises Aloe barbadensis; and
the biocide further comprises a biologically derived enzyme.

10. The building surface treatment biocide of claim 9, further comprising a pH adjusting agent present in an effective amount to establish the building surface treatment biocide at a pH in a range of about 3.1 to about 4.5, the pH adjusting agent comprising a fatty acid.

11. A method for the treatment of a building surface, comprising:
contacting a building surface with an effective amount of the building surface treatment biocide of claim 1 to treat microbial growth, the building surface treatment biocide comprising a nonionic surfactant, an antimicrobial agent, and a botanical extract of a plant selected from the Liliaceae and Cactus families, the extract retaining active enzymes and amino acids of the plant.

12. The method of claim 11, further comprising an acidic pH adjusting agent present in an effective amount to establish the building surface treatment biocide at a pH in a range of about 3.1 to about 4.5.

13. The method of claim 12, further comprising a biologically derived enzyme.

14. The method of claim 13, wherein said contacting comprises spraying the building surface treatment biocide against the building surface.

15. A building surface treatment aqueous biocide, comprising:
aseptic water;
a nonionic surfactant; and
an botanical extract from a plant selected from the Liliaceae and Cactus families, the extract retaining active enzymes and amino acids of the plant.

16. The building surface treatment aqueous biocide of claim 15, wherein the botanical extract comprises Aloe barbadensis.

17. A method for the treatment of a building surface, comprising:
contacting a building surface with an effective amount of the building surface treatment aqueous biocide of claim 15 to treat microbial growth, the building surface treatment biocide comprising aseptic water, a nonionic surfactant, and a botanical extract of a plant selected from the Liliaceae and Cactus families, the extract retaining active enzymes and amino acids of the plant.

18. An building surface treatment biocide, comprising:
an enzyme;
a nonionic surfactant;
an antimicrobial agent;
a penetrant;
mucilaginous polysaccharides; and
amino acids.

19. The building surface treatment biocide of claim 18, further comprising an acidic pH adjusting agent present in an effective amount to establish the building surface treatment biocide at a pH in a range of about 3.1 to about 4.5.

20. The building surface treatment biocide of claim 19, wherein the pH adjusting agent comprises a fatty acid.

21. The building surface treatment biocide of claim 18, wherein the nonionic surfactant comprises a polyoxyethylene sorbitan fatty acid ester.

22. The building surface treatment biocide of claim 18, wherein the antimicrobial agent comprises an isothiazolin compound.

23. The building surface treatment biocide of claim 19, wherein:
the nonionic surfactant comprises a polyoxyethylene sorbitan fatty acid ester;
the antimicrobial agent comprises an isothiazolin compound; and
the pH adjusting agent comprises a fatty acid.

24. A method for the treatment of a building surface, comprising:
contacting a building surface with an effective amount of the building surface treatment biocide of claim 18 to treat microbial growth on the building surface.

25. The method of claim 24, further comprising an acidic pH adjusting agent present in an effective amount to establish the building surface treatment biocide at a pH in a range of about 3.1 to about 4.5.

26. The method of claim 25, wherein the pH adjusting agent comprises a fatty acid.

27. The method of claim 24, wherein the nonionic surfactant comprises a polyoxyethylene sorbitan fatty acid ester.

28. The method of claim 24, wherein the antimicrobial agent comprises an isothiazolin compound.

29. The method of claim 25, wherein:
the nonionic surfactant comprises a polyoxyethylene sorbitan fatty acid ester;
the antimicrobial agent comprises an isothiazolin compound; and
the pH adjusting agent comprises a fatty acid.
